(19) United States
(12) Patent Application Publication
(10) Pub. No.: US 2025/0388502 A1
(43) Pub. Date: Dec. 25, 2025

(54) BIOELECTROACTIVE AMMONIA EXTRACTION MEMBRANE FOR AMMONIA RECOVERY FROM WASTEWATER AND PREPARATION METHOD THEREOF

(71) Applicant: NANJING UNIVERSITY, Nanjing (CN)

(72) Inventors: Xuxiang ZHANG, Nanjing (CN); Qinzhen Zhang, Nanjing (CN); Wei Zhao, Nanjing (CN); Depeng Wang, Nanjing (CN); Kailong Huang, Nanjing (CN)

(21) Appl. No.: 19/316,669

(22) Filed: Sep. 2, 2025

(30) Foreign Application Priority Data
Nov. 22, 2024 (CN) 202411676775.0

(51) Int. Cl. C02F 3/00; C02F 101/16

(52) U.S. Cl. CPC C02F 3/005; C02F 2101/16; C02F 2201/46115; C02F 2203/006

(57) ABSTRACT

The present invention discloses a bioelectroactive ammonia extraction membrane for ammonia recovery from wastewater, which includes a cation exchange membrane, where two opposite sides of the cation exchange membrane are separately provided with a bioanode and an ammonia extraction cathode; and a flow channel mesh in contact with the wastewater is laid on a bioanode side, and a flow channel mesh in contact with air is laid on an ammonia extraction cathode side. When the bioelectroactive ammonia extraction membrane of the present invention is applied to ammonia recovery from high-COD and high ammonia-nitrogen wastewater, not only can a high-purity aqueous ammonia solution be obtained, but also energy consumption for ammonia recovery as low as 1.16 kWh/kg NH3-N can be achieved. Compared with the traditional electrochemical ammonia recovery technology under the same conditions, energy consumption for ammonia extraction in the present invention is reduced by more than 65%

### TECHNICAL FIELD

The present invention relates to a bioelectroactive ammonia extraction membrane for ammonia recovery from wastewater, and also relates to a method for preparing the above bioelectroactive ammonia extraction membrane, belonging to the technical field of wastewater treatment.

### BACKGROUND

Traditional biological nitrogen removal (BNR) converts NH3-N into free N2, which not only results in an energy consumption of 12.5 kWh/kg NH3-N, but also contributes to carbon emissions of 0.9 kg CO2/m3 wastewater, and may even cause emissions of N2O with high global warming potential. However, ammonia and derived chemicals thereof are key high-efficiency fertilizers for sustainable agriculture. Currently, almost all ammonia production relies on the Haber-Bosch process (about 14 kWh/kg NH3-N), which accounts for 1.0% of global energy consumption and contributes 1.4% of global carbon emissions. Therefore, recovering ammonia from wastewater is both environmentally sustainable and economically necessary.

Traditional wastewater ammonia recovery technologies mainly include air stripping, chemical precipitation, and ion exchange methods. The air stripping method is operationally simple and suitable for high-concentration ammonia-nitrogen wastewater, in which the ammonia removal rate can reach over 80%. However, due to the complex composition of wastewater, the purity of the recovered ammonium sulfate and ammonia water is not high, which cannot offset the cost of alkali addition required to increase the pH of wastewater during ammonia stripping or ammonia distillation. Ultimately, this leads to a high cost for nitrogen removal from wastewater. The chemical precipitation method has a fast reaction rate and is suitable for high-concentration wastewater. Moreover, the produced struvite can be used for resource recovery. Nevertheless, this method requires the addition of a large number of chemical agents, resulting in high operating costs. The ion exchange method features good continuity, but it also has drawbacks such as large usage of resins, zeolites, and regenerated salt solutions, susceptibility to resin clogging, and small processing capacity. Therefore, high energy consumption, high operating and investment costs, and difficulty in obtaining high-purity and high-value ammonia extraction products are among the key technical bottlenecks in the current recovery of ammonia-nitrogen wastewater.

### SUMMARY

Objectives of the Invention: An objective of the present invention is to provide a bioelectroactive ammonia extraction membrane for ammonia recovery from wastewater. The ammonia extraction membrane can effectively reduce energy consumption in an ammonia extraction process and obtain high-purity ammonia products. Another objective of the present invention is to provide a method for preparing the above bioelectroactive ammonia extraction membrane.

Technical Solutions: The bioelectroactive ammonia extraction membrane according to the present invention includes a cation exchange membrane; two opposite sides of the cation exchange membrane are separately provided with a bioanode and an ammonia extraction cathode; and a flow channel mesh in contact with the wastewater is laid on a bioanode side, and a flow channel mesh in contact with air is laid on an ammonia extraction cathode side.

The cation exchange membrane is Nafion 117 or Nafion 115.

The bioanode is a carbon-based current collector loaded with activated sludge, the ammonia extraction cathode is a carbon-based current collector loaded with an oxygen reduction catalyst, and the carbon-based current collector is preferably carbon paper.

Materials of both the wastewater-side flow channel mesh and the air-side flow channel mesh are polypropylene or nylon, with a thickness of 0.2-2.0 mm and a mesh size of 20-100 mesh, and preferably, polypropylene with a mesh size of 40 mesh. Arrangement of the flow channel meshes can increase the mass transfer rate between the membrane and liquid, and also improve the contact efficiency between the electrode (ammonia extraction cathode) and the air, thereby enhancing the reaction efficiency between the membrane and the wastewater and the air, and improving the overall ammonia extraction efficiency of the device.

A method for preparing the above bioelectroactive ammonia extraction membrane includes the following steps:
(1) adding glass microbeads to activated sludge and dispersing by shaking to form a uniform activated sludge suspension, where the glass microbeads are used to break up the flocculent sludge; smaller sizes of glass microbeads result in smaller particle sizes of sludge particles formed after dispersion; on one hand, the smaller particle sizes of sludge particles facilitate easier penetration into a carbon-based current collector, thereby increasing a loading amount of the activated sludge on the carbon-based current collector, and on the other hand, the smaller particle sizes promote more efficient biofilm formation, thus enhancing the biological activity;
(2) uniformly loading the activated sludge suspension onto the carbon-based current collector by means of suction filtration to form the bioanode;
(3) adding multi-walled carbon nanotubes and a Nafion solution into anhydrous ethanol, and performing ultrasonic treatment to form a uniform multi-walled carbon nanotube dispersion;
(4) adding an oxygen reduction catalyst into anhydrous ethanol, and performing ultrasonic treatment to form a uniform oxygen reduction catalyst dispersion;
(5) dropwise adding the oxygen reduction catalyst dispersion into the multi-walled carbon nanotube dispersion and mixing thoroughly by stirring to form a precursor solution for the ammonia extraction cathode;
(6) uniformly loading the precursor solution for the ammonia extraction cathode onto the carbon-based current collector by means of spraying to form the ammonia extraction cathode;
(7) fixing the bioanode on one side of the cation exchange membrane, and fixing the ammonia extraction cathode on the other side of the cation exchange membrane; and
(8) laying flow channel meshes on the bioanode side and the ammonia extraction cathode side of the cation exchange membrane separately to obtain the bioelectroactive ammonia extraction membrane.

In step (1), an average diameter of the glass microbeads is 50-200 μm.

In step (1), the activated sludge is derived from a microbial fuel cell reactor, and the activated sludge suspension has a sludge concentration of 1.0-10 g/L.

In step (2), the carbon-based current collector has a loading amount of activated sludge of 10-1000 mg/cm2.

In step (2) and step (6), the carbon-based current collector has a thickness of 0.1-0.5 mm, a bulk density of 0.3-0.5 g/cm3, a porosity of 70-80%, and a resistivity of less than 100 mΩ·cm.

In step (3), the multi-walled carbon nanotube dispersion has a concentration of 0.5-2.0 g/L; the Nafion solution has a concentration of 1.0-20 wt %; and a volume ratio of the Nafion solution to the anhydrous ethanol is 1:1000-1:10000.

In step (4), the oxygen reduction catalyst is iron phthalocyanine and/or manganese phthalocyanine; and the oxygen reduction catalyst dispersion has a concentration of 1.0-100 mg/L.

In step (5), the oxygen reduction catalyst dispersion has a dripping speed of 0.1-100 mL/min.

In step (6), the carbon-based current collector has a loading amount of the oxygen reduction catalyst of 0.1-1.0 mg/cm2.

An ammonia recovery device containing the above bioelectroactive ammonia extraction membrane, including a reactor and the bioelectroactive ammonia extraction membrane disposed in the reactor, where the bioelectroactive ammonia extraction membrane separates the reactor into two independent chambers, where a chamber corresponding to a bioanode side is a wastewater flow-through chamber, and a chamber corresponding to an ammonia extraction cathode side is an air flow-through chamber; dry air enters the air flow-through chamber from an air inlet of the chamber, and an air outlet of the air flow-through chamber is connected to a condensation absorption unit for separating air and ammonia gas; and the bioelectroactive ammonia extraction membrane is connected to an external power source through a wire.

High-COD and high ammonia-nitrogen wastewater is pumped into the wastewater flow-through chamber. Organic matter in the wastewater is catalytically degraded under the action of electroactive bacteria in the bioanode, with electrons released. The electrons are transferred to an external circuit through a bioanode interface. Upon reaching the ammonia extraction cathode, the electrons reduce 02 in the air under the action of the catalyst to generate OH—, forming a localized strongly alkaline microenvironment. Driven by electric field force, NH4+ in the wastewater crosses the cation exchange membrane, combines with OH— at the ammonia extraction cathode, and is converted into NH3 (g). The generated NH3 (g) enters a low-temperature water absorption solution through the air flow channel mesh to form an aqueous ammonia solution, realizing the recovery of high-purity ammonia from the wastewater. When the bioelectroactive ammonia extraction membrane of the present invention is applied to ammonia extraction from high-COD and high ammonia-nitrogen wastewater, low-energy-consumption ammonia recovery from wastewater can be achieved, and a high-purity aqueous ammonia solution can be directly obtained.

Advantageous Effects: Compared with the prior art, the present invention has the following remarkable advantages: when the bioelectroactive ammonia extraction membrane of the present invention is applied to ammonia recovery from high-COD and high ammonia-nitrogen wastewater, not only can a high-purity aqueous ammonia solution be obtained, but also energy consumption for ammonia recovery as low as 1.16 kWh/kg NH3-N can be achieved. Compared with the traditional electrochemical ammonia recovery technology under the same conditions, energy consumption for ammonia extraction in the present invention is reduced by more than 65%.

### BRIEF DESCRIPTION OF THE DRAWINGS

FIG. 1 is a schematic structural diagram of ammonia extraction by an ammonia recovery device containing a bioelectroactive ammonia extraction membrane, where A is a schematic structural diagram of the ammonia recovery device containing the bioelectroactive ammonia extraction membrane; B is a schematic structural diagram of the bioelectroactive ammonia extraction membrane;

FIG. 2 shows Faradaic efficiency for ammonia extraction and energy consumption for ammonia extraction of a bioelectroactive ammonia extraction membrane under different current densities, where a, c, and e correspond to Faradaic efficiency for ammonia extraction for ammonia extraction when air flow rates are 20 mL/min, 30 mL/min, and 80 mL/min, respectively, and b, d, and f correspond to energy consumption when air flow rates are 20 mL/min, 30 mL/min, and 80 mL/min, respectively; and

FIG. 3 is purity determination of a recovered aqueous ammonia solution.

### DETAILED DESCRIPTION

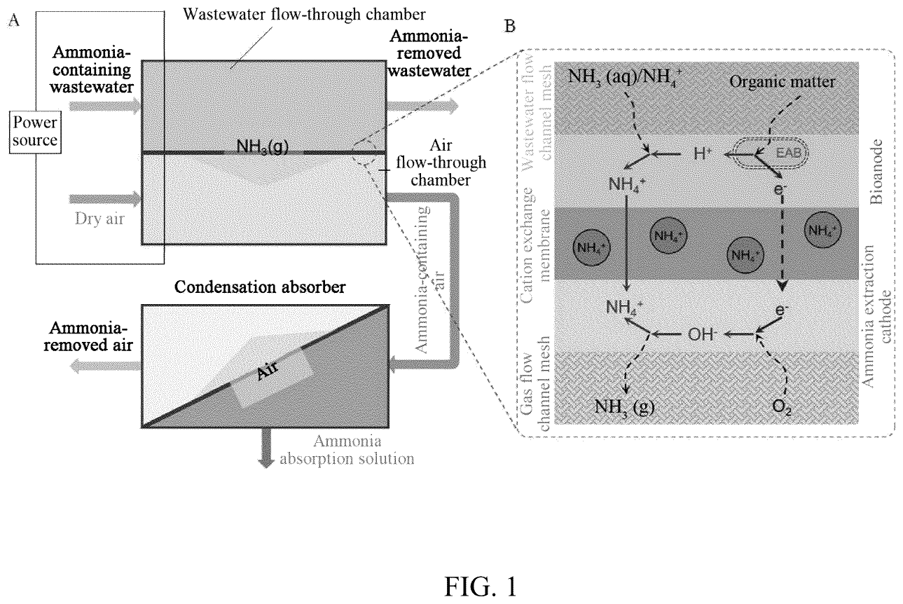

As shown in FIG. 1, the bioelectroactive ammonia extraction membrane of the present invention includes a cation exchange membrane; two opposite sides of the cation exchange membrane are separately provided with a bioanode and an ammonia extraction cathode; and a flow channel mesh in contact with wastewater is laid on a bioanode side, and a flow channel mesh in contact with air is laid on an ammonia extraction cathode side, where the cation exchange membrane is Nafion 117.

The above bioelectroactive ammonia extraction membrane is composed of a wastewater-side flow channel mesh, a bioanode, a cation exchange membrane, an ammonia extraction anode, and an air-side flow channel mesh. The preparation method thereof specifically included the following steps:
(1) glass microbeads with an average diameter of 100 μm were added to activated sludge, and the mixture was dispersed by shaking to form an activated sludge suspension with an MLSS of 7.0 g/L, where the activated sludge was derived from a microbial fuel cell reactor;
(2) the above activated sludge suspension was uniformly loaded onto a carbon-based current collector by means of suction filtration to form a bioanode, where the carbon-based current collector had a commercial model of TGP-H-060, a thickness of 0.19 mm, a bulk density of 0.44 g/cm3, a porosity of 78%, and a resistivity of 80 mΩ·cm; and the carbon-based current collector had a loading amount of the activated sludge of 63.3 mg/cm2;
(3) 100 mg of multi-walled carbon nanotubes (MWCNT, Aladdin, C139872) and 20 μL of a 5 wt % Nafion solution (Dupont, D-520) were added to 100 mL of anhydrous ethanol, and after 4.0 h of ultrasonic treatment, a multi-walled carbon nanotube dispersion with a concentration of 1.0 g/L was formed;
(4) 1.0 mg of iron phthalocyanine (FePc, Aladdin I157718) was added to 100 mL of anhydrous ethanol, and after 4.0 h of ultrasonic treatment, an oxygen reduction catalyst dispersion with a concentration of 10 mg/L was formed;
(5) 100 mL of the above oxygen reduction catalyst dispersion was added dropwise into 100 mL of the multi-walled carbon nanotube dispersion at a dripping rate of 5.0 mL/min, and the mixture was mixed thoroughly by stirring to form a precursor solution for an ammonia extraction cathode;
(6) the precursor solution for the ammonia extraction cathode was uniformly loaded onto a 2.0×2.0 cm2 carbon-based current collector by means of spraying to form the ammonia extraction cathode (air-dried naturally after spraying), where the carbon-based current collector has a loading amount of the iron phthalocyanine of 0.25 mg/cm2;
(7) the bioanode was fixed on one side of a cation exchange membrane, and the ammonia extraction cathode was fixed on the other side of the cation exchange membrane; and
(8) polypropylene with a thickness of 1.0 mm and a mesh size of 40 mesh was cut into the size of the cation exchange membrane and laid on the bioanode side and the ammonia extraction cathode side of the cation exchange membrane separately to obtain the bioelectroactive ammonia extraction membrane; and the flow channel meshes, carbon-based current collectors, and cation exchange membrane were fixedly connected at the outer edges.

An ammonia recovery device containing the above bioelectroactive ammonia extraction membrane includes a reactor and the bioelectroactive ammonia extraction membrane disposed in the reactor, and the bioelectroactive ammonia extraction membrane separates the reactor into two independent chambers, where a chamber corresponding to a bioanode side is a wastewater flow-through chamber, and a chamber corresponding to an ammonia extraction cathode side is an air flow-through chamber; dry air enters the air flow-through chamber from an air inlet of the chamber, and an air outlet of the air flow-through chamber is connected to a condensation absorption unit for separating air and ammonia gas (the condensation absorption unit contains a low-temperature water absorption solution); the mixed gas of air and ammonia gas is separated in the condensation absorption unit, with the separated air discharged, and the separated ammonia gas absorbed by the low-temperature water absorption solution to form an aqueous ammonia solution; and the bioelectroactive ammonia extraction membrane is connected to an external power source through a wire. One side of the wastewater flow-through chamber is provided with a water inlet, and external wastewater to be treated enters the wastewater flow-through chamber through the water inlet. The other side of the wastewater flow-through chamber is provided with a water outlet, and nitrogen-removed wastewater flows out of the wastewater flow-through chamber through the water outlet.

The above ammonia recovery device was applied to ammonia extraction from livestock and poultry breeding wastewater. The specific operation process was as follows: the water quality characteristics of poultry breeding wastewater were as follows: a COD concentration was about 3000 mg/L, an ammonia nitrogen concentration was about 820 mg/L, and pH was between 6 and 8;
(1) the livestock and poultry breeding wastewater was pumped into the wastewater flow-through chamber, with a hydraulic retention time of 2.0 h;
(2) dust-free and dry air was pumped into the air flow-through chamber at flow rates of 20 mL/min, 30 mL/min, and 80 mL/min separately; and
(3) the air outlet of the air flow-through chamber was connected to a device containing a 4° C. low-temperature water absorption solution, and the mixed gas was fed into the 4° C. low-temperature water absorption solution to separate ammonia gas from air, with the air discharged and the ammonia gas absorbed to form an aqueous ammonia solution.

By testing the concentration of the aqueous ammonia solution under different current densities, the Faradaic efficiency for ammonia extraction and energy consumption for ammonia extraction of the bioelectroactive ammonia extraction membrane under different current densities were calculated.

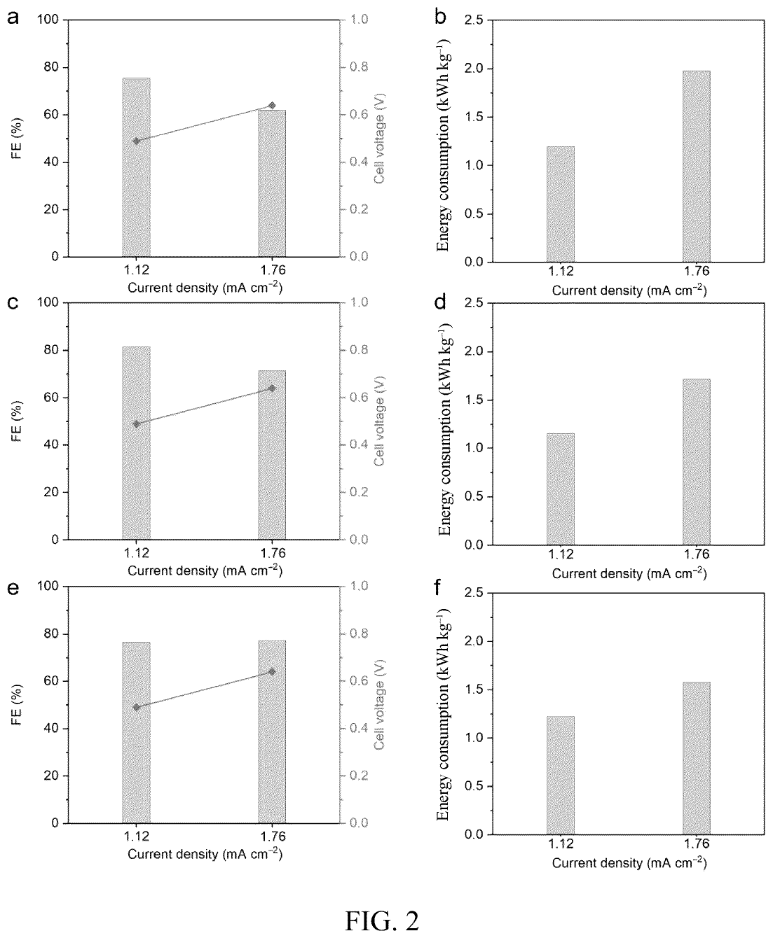

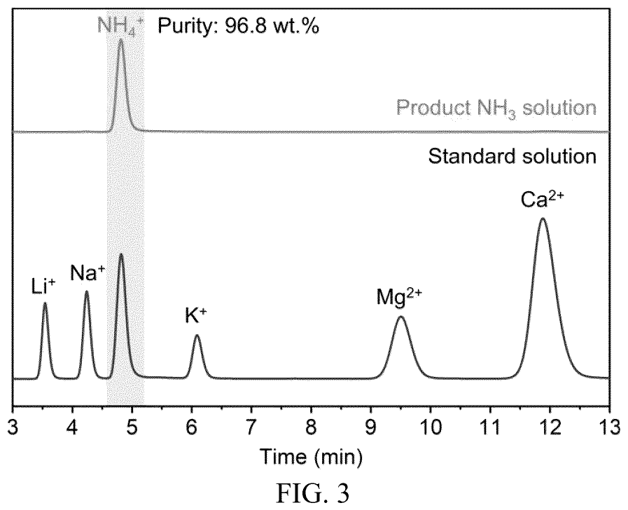

The results are shown in FIG. 2. Under the conditions of a current density of 1.12 mA cm−2 and air flow rates of 20 mL/min, 30 mL/min, and 80 mL/min, Faradaic efficiencies for ammonia extraction of 75.7%, 81.5%, and 76.6% were achieved, respectively (FIG. 2a, FIG. 2c, FIG. 2e). At this time, the voltage across the bioelectroactive ammonia extraction membrane was 0.49 V (FIG. 2a, FIG. 2c, FIG. 2e), and the corresponding energy consumption for ammonia extraction was 1.23 kWh/kg NH3-N, 1.16 kWh/kg NH3-N, and 1.22 kWh/kg NH3-N (FIG. 2b, FIG. 2d, FIG. 2f). Under the conditions of a current density of 1.76 mA cm−2 and air flow rates of 20 mL/min, 40 mL/min, and 80 mL/min, Faradaic efficiencies for ammonia extraction of 62%, 71.4%, and 77.4% were achieved, respectively (FIG. 2a, FIG. 2c, FIG. 2e). At this time, the voltage across the bioelectroactive ammonia extraction membrane was 0.64 V (FIG. 2a, FIG. 2c, FIG. 2e), and the corresponding energy consumption for ammonia extraction was 1.98 kWh/kg NH3-N, 1.72 kWh/kg NH3-N, and 1.58 kWh/kg NH3-N (FIG. 2b, FIG. 2d, FIG. 2f), which is comparable to energy consumption for the most advanced electrochemical ammonia recovery of 1.61 kWh/kg NH3-N reported in current literature. In addition, the purity of the recovered aqueous ammonia solution reached 96.8 wt % (as shown in FIG. 3), meeting the purity requirements for industrial-grade aqueous ammonia solutions.

What is claimed is:

1. A wastewater ammonia recovery device containing a bioelectroactive ammonia extraction membrane, comprising a reactor and the bioelectroactive ammonia extraction membrane disposed in the reactor, wherein the bioelectroactive ammonia extraction membrane separates the reactor into two independent chambers, wherein a chamber corresponding to a bioanode side is a wastewater flow-through chamber, and a chamber corresponding to an ammonia extraction cathode side is an air flow-through chamber; dry air enters the air flow-through chamber from an air inlet of the chamber, and an air outlet of the air flow-through chamber is connected to a condensation absorption unit for separating air and ammonia gas; and the bioelectroactive ammonia extraction membrane is connected to an external power source through a wire,
wherein the bioelectroactive ammonia extraction membrane comprises a cation exchange membrane; two opposite sides of the cation exchange membrane are separately provided with a bioanode and an ammonia extraction cathode; a flow channel mesh in contact with wastewater is laid on the bioanode side, and a flow channel mesh in contact with air is laid on the ammonia extraction cathode side; and materials of both the wastewater-side flow channel mesh and the air-side flow channel mesh are polypropylene or nylon, with a thickness of 0.2-2.0 mm and a mesh size of 20-100 mesh, and
wherein a method for preparing the above bioelectroactive ammonia extraction membrane comprises the following steps: (1) adding glass microbeads to activated sludge and dispersing by shaking to form a uniform activated sludge suspension; (2) uniformly loading the activated sludge suspension onto a carbon-based current collector by means of suction filtration to form the bioanode; (3) adding multi-walled carbon nanotubes and a Nafion solution into anhydrous ethanol, and performing ultrasonic treatment to form a uniform multi-walled carbon nanotube dispersion; (4) adding an oxygen reduction catalyst into anhydrous ethanol, and performing ultrasonic treatment to form a uniform oxygen reduction catalyst dispersion; (5) dropwise adding the oxygen reduction catalyst dispersion into the multi-walled carbon nanotube dispersion and mixing thoroughly by stirring to form a precursor solution for the ammonia extraction cathode; (6) uniformly loading the precursor solution for the ammonia extraction cathode onto the carbon-based current collector by means of spraying to form the ammonia extraction cathode; (7) fixing the bioanode on one side of the cation exchange membrane, and fixing the ammonia extraction cathode on the other side of the cation exchange membrane; and
(8) laying flow channel meshes on the bioanode side and the ammonia extraction cathode side of the cation exchange membrane separately to obtain the bioelectroactive ammonia extraction membrane.

2. The wastewater ammonia recovery device containing a bioelectroactive ammonia extraction membrane according to claim 1, wherein the cation exchange membrane is Nafion 117 or Nafion 115.

3. The wastewater ammonia recovery device containing a bioelectroactive ammonia extraction membrane according to claim 1, wherein the carbon-based current collector has a thickness of 0.1-0.5 mm, a bulk density of 0.3-0.5 g/cm3, a porosity of 70-80%, and a resistivity of less than 100 mΩ·cm.

4. The wastewater ammonia recovery device containing a bioelectroactive ammonia extraction membrane according to claim 1, wherein in step (1), the glass microbeads have an average diameter of 50-200 μm; and the activated sludge suspension has a sludge concentration of 1.0-10 g/L; and in step (2), the carbon-based current collector has a loading amount of the activated sludge of 10-1000 mg/cm2.

5. The wastewater ammonia recovery device containing a bioelectroactive ammonia extraction membrane according to claim 1, wherein in step (3), the multi-walled carbon nanotube dispersion has a concentration of 0.5-2.0 g/L; the Nafion solution has a concentration of 1.0-20 wt %; and a volume ratio of a dosage of the Nafion solution to the anhydrous ethanol is 1:1000-1:10000.

6. The wastewater ammonia recovery device containing a bioelectroactive ammonia extraction membrane according to claim 1, wherein in step (4), the oxygen reduction catalyst is iron phthalocyanine and/or manganese phthalocyanine; and the oxygen reduction catalyst dispersion has a concentration of 1.0-100 mg/L; in step (5), the oxygen reduction catalyst dispersion has a dripping speed of 0.1-100 mL/min; and in step (6), the carbon-based current collector has a loading amount of the oxygen reduction catalyst of 0.1-1.0 mg/cm2.
